(19) United States
(12) Patent Application Publication
(10) Pub. No.: US 2004/0143747 A1
(43) Pub. Date: Jul. 22, 2004

(54) Preventing the unwanted external detection of operations in digital integrated circuits

(75) Inventors: Gernot Eckstein, Neufahrn (DE); Christian Aumueller, Weilheim (DE); Stefan Wallstab, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/735,517

(22) Filed: Dec. 11, 2003

Related U.S. Application Data
(63) Continuation of application No. PCT/EP02/05428, filed on May 16, 2002.

(30) Foreign Application Priority Data
Jun. 13, 2001 (DE) 101 28 573.6

(51) Int. Cl. H04L 9/32; G06F 11/30; G06F 12/14

(52) U.S. Cl. 713/189

(57) ABSTRACT

In a digital circuit comprising an asynchronous circuit, the supply voltage of the asynchronous circuit is varied by means of a random voltage jitter. The random variation of the supply voltage causes a time jitter in the processing of the individual operations within the asynchronous circuit, whereby an artificial synchronizing of individual measurements in side channel attacks is prevented.

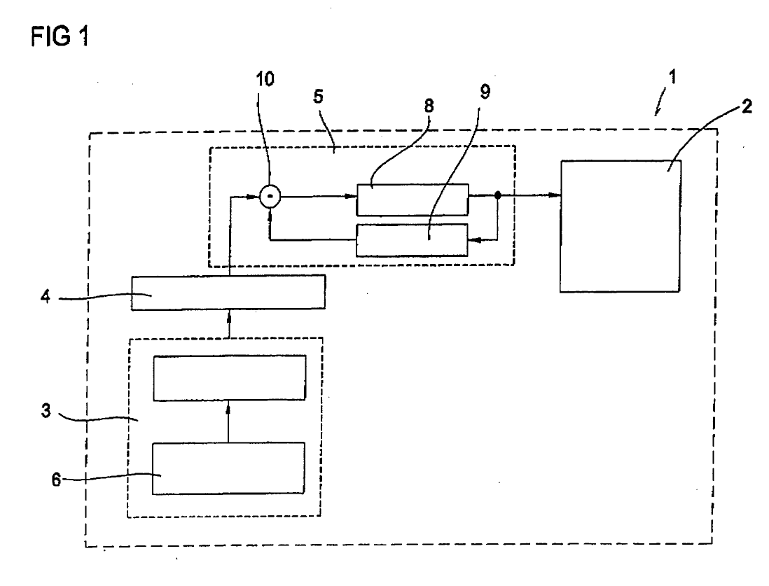

### CROSS-REFERENCE TO RELATED APPLICATION

This application is a continuation of copending International Application No. PCT/EP02/05428, filed May 16, 2002, which designated the United States and was not published in English.

### BACKGOUND OF THE INVENTION

1. Field of the Invention

The present invention relates to a method of preventing the external detection of operations in a digital integrated circuit and to a digital integrated circuit in which the unwanted external detection of operations within the digital integrated circuit is prevented. The present invention especially relates to a countermeasure for so-called side channel attacks, as are performed for analyzing digital integrated circuits.

2. Description of the Related Art

In many digital integrated circuits, unauthorized persons must be prevented from analyzing the mode of operation of same. Exemplary circuits in which such attack scenarios are to be warded off are chip card ICs, safety ICs or even individual circuit modules of such ICs, such as, for example, cryptocoprocessors. It need not be explained that unauthorized persons must be prevented from analyzing coding algorithms performed by a cryptocoprocessor.

Typical attack scenarios with which unauthorized persons, for example, try to analyze coding algorithms carried out by a cryptocoprocessor are referred to as so-called side channel attacks. Such side channel attacks include, for example, the differential power consumption analysis (DPA=differential power analysis), the detection of electro-magnetic radiation of the IC concerned and so-called timing attacks.

In contrast to synchronous circuits, asynchronous circuits, among which self-timed circuits are, have the advantageous feature that the processing of same is not directly correlated to a time-periodic event, such as the clock. Thus, the processing of same does not show any dependency on such a time-periodic event, whereby it is more difficult in the asynchronous circuits to successfully perform side channel attacks. However, even in asynchronous circuits, the number of switching elements is generally dependent on the special operation to be processed, so that in general processing data dependencies which are reflected in the profile of the power consumption of the circuit concerned occur.

In order to make such attacks more difficult, it is known to insert so-called random wait states into the process flow. It is also known to force interruptions in the execution of operations in the CPU. In the insertion of random wait states, possible variations of the timing of operations are limited, since a delay cannot be activated or a wait state cannot be inserted at any time. Even the measure of interrupting the execution in the CPU cannot completely block side channel attacks, since such interruptions can be detected by the varying power consumption.

### SUMMARY OF THE INVENTION

It is the object of the present invention to provide a method of preventing the external detection of operations in a digital integrated circuit comprising an asynchronous circuit.

Another object of the present invention is to develop a digital integrated circuit having an asynchronous circuit in such a way that the unwanted external detection of operations in the digital circuit is prevented.

In accordance with a first aspect, the present invention provides a method of preventing the external detection of operations in a digital integrated circuit having an asynchronous circuit, having the method step of time-varying a supply voltage of the asynchronous circuit to time-shift the execution time of operations within the asynchronous circuit.

In accordance with a second aspect, the present invention provides a digital integrated circuit having an asynchronous circuit, and means for time-varying a supply voltage of the asynchronous circuit to time-shift the execution point of operations within the asynchronous circuit.

In other words, the invention provides a method of preventing the external detection of operations in an integrated circuit comprising an asynchronous circuit, comprising the method step of time-varying a supply voltage of the asynchronous circuit to shift the time of execution of operations within the asynchronous circuit in time. In a preferred aspect of the invention, this variation of the supply voltage takes place in a random way.

The invention is based on the finding that a random time jitter in the execution times of the operations is obtained by superimposing a randomly-controlled, that is unpredictable, time jitter on the supply voltage, whereby an artificial synchronizing of the individual measurements in the side channel attack is prevented. The time jitter in the execution of the operations within the asynchronous circuit, however, does not lead to processing errors since, according to their nature, asynchronous circuits effect an auto-synchronization.

According to a device aspect of the invention, the digital integrated circuit includes an asynchronous circuit and a means for time-varying the supply voltage with which the asynchronous circuit is supplied, whereby the execution time of operations within the asynchronous circuit is time-shifted.

### BRIEF DESCRIPTION OF THE DRAWINGS

In the following, a preferred embodiment of the present invention will be detailed referring to the enclosed drawing.

The one and only FIGURE shows a block diagram of a digital integrated circuit according to a preferred embodiment of the invention.

### DESCRIPTION OF THE PREFERRED EMBODIMENTS

The inventive digital integrated circuit in its entirety referred to with the reference numeral 1 includes an asynchronous circuit 2, a generator circuit 3 for generating true random numbers (true random number generator), a digital-analog converter 4 to which, on the input side, digital random numbers produced by the generator circuit are fed and which, on the output side, produces a corresponding analog target voltage value, and a voltage regulator 5 to which, on the input side, the analog target voltage value is fed from the digital-analog converter 4 and which, on the output side, generates an actual voltage value forming the supply voltage of the asynchronous circuit 2. The generator circuit 3 for producing true random numbers, in turn, includes a noise source 6 generating a noise voltage and a random number generator 7 driven by the noise source 6.

Instead of the combination of the noise source 6 and the random number generator 7 shown here, however, any other random generators can be used for generating the random numbers as input quantities for the digital-analog converter 4.

In the preferred embodiment shown here, the voltage regulator 5 comprises a servo component 8, an actual value detection device 9 and a difference-forming device 10, to the inputs of which, on the one hand, the analog target voltage value from the digital-analog converter 4 and, on the other hand, an output signal from the actual value detection device 9 are fed.

The generator circuit 3, the digital-analog converter 4 and the voltage regulator 5 together form a means for randomly time-varying the supply voltage or a means for superimposing a random time jitter on the supply voltage, with which the asynchronous circuit 2 is supplied, respectively. Due to the randomly varying supply voltage, there is a random time jitter in the execution of operations in the asynchronous circuit, whereby the artificial synchronizing of the individual measurements in the so-called side channel attacks is prevented or, at least, made more difficult.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A method of preventing the external detection of operations in a digital integrated circuit comprising an asynchronous circuit,
comprising the method step of time-varying a supply voltage of said asynchronous circuit to time-shift the execution time of operations within said asynchronous circuit.

2. The method according to claim 1, wherein the time variation of said supply voltage takes place in a random way.

3. A digital integrated circuit comprising:
an asynchronous circuit, and
means for time-varying a supply voltage of said asynchronous circuit to time-shift the execution point of operations within said asynchronous circuit.

4. The digital integrated circuit according to claim 3, wherein said means for time-varying said supply voltage comprises a random number generator.

5. The digital integrated circuit according to claim 4, wherein said means for time-varying said supply voltage further comprises a noise voltage source driving said random-number generator.

6. The digital integrated circuit according to claim 4, wherein said means for time-varying said supply voltage further comprises a digital-analog converter transforming the digital values produced by said random-number generator into an analog voltage.

7. The digital integrated circuit according to claim 3, wherein said means for time-varying said supply voltage further comprises a voltage regulator.

8. The digital integrated circuit according to claim 3, wherein said asynchronous circuit is formed for executing a coding algorithm.
